(19) United States
(12) Patent Application Publication
(10) Pub. No.: US 2005/0206814 A1
(43) Pub. Date: Sep. 22, 2005

(54) Liquid crystal display device

(76) Inventor: Yuzo Histake, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/078,318

(22) Filed: Mar. 14, 2005

(30) Foreign Application Priority Data
Mar. 18, 2004 (JP) 2004-077642

(51) Int. Cl. G02F 1/1335

(52) U.S. Cl. 349/112

(57) ABSTRACT

A liquid crystal display device having a plurality of display modes of viewing angle properties different from each other, comprising a liquid crystal display panel, a backlight unit, a phase control liquid crystal element, a luminance visual angle control liquid crystal element, and a drive unit. The drive unit drives the phase control liquid crystal element and the luminance visual angle control liquid crystal element in accordance with a respective one of the plurality of display modes.

### CROSS-REFERENCE TO RELATED APPLICATIONS

This application is based upon and claims the benefit of priority from prior Japanese Patent Application No. 2004-077642, filed Mar. 18, 2004, the entire contents of which are incorporated herein by reference.

### BACKGROUND OF THE INVENTION

1. Field of the Invention

The present invention relates to a liquid crystal display device.

2. Description of the Related Art

Recently, liquid crystal display device are applied in various fields including note-type personal computers, monitors, car navigations, functional calculators, small- to middle-sized televisions, large-sized televisions, mobile telephones and electronic notepads.

These liquid crystal displays have wide viewing angles and high contrasts due to the realization of the thin film transistor (TFTs), and the application of the in-plane switching mode (IPS), multi-vertical align mode (MVA) and wide view film.

Of these liquid crystal display device, those for car navigations, electronic notepads, personal digital assistants (PDA), mobile telephones, factory automations (FAs), ATMs, ticket-vending machines and tablet personal computers (PC) are provided with a touch panel of a data entry function in the front surface of the device.

When these device with touch panels are operated, there are situations in which the display on the screen should not be monitored by others than the user especially when the user operates electronic notepads, PDAs, mobile telephones, FAs, ATMs and tablet personal computers. For examples, such situations are where private contents are displayed in a public place on a mobile phone, PDA or tablet PC. In these cases, the viewing angle property should desirably be narrow. However, in consideration of the cases where two or more persons need to monitor the display image at the same time, it is desired that the device should be provided with the function of controlling its viewing angle.

More recently, as means for controlling the viewing angle of liquid crystal displays or cathode ray tubes (CRTs), a detachable louver (for example, Light Control Film; a product of 3M) is used as discussed in Jpn. Pat. Appln. KOKAI Publication No. 2003-58066. Meanwhile, some of the liquid crystal display device that uses a polarizing plate employ such an applied system that a polarizing plate on the observer side is not provided, but in place, only when the user wears a polarizing glasses, the displayed contents can be identified.

A conventional louver sheet is provided with a light shielding layer of about several millimeters in the direction of the normal to the sheet in order to sufficiently narrow the viewing angle. Therefore, the method using a louver sheet entails a drawback of a low light transmittance. The processing step for the louver sheet is complicated and the production cost is high. Further, when attaching or detaching a louver sheet, it takes the user time and labor. In the meantime, the method that uses a pair of polarizing glasses, entails the drawback where the displayed image cannot be monitored publicly by some other persons.

The present invention has been achieved in consideration of the above-described drawbacks of the conventional techniques and the object thereof is to provide a liquid crystal display device having an excellent viewing angle control.

### BRIEF SUMMARY OF THE INVENTION

In order to solve the described drawbacks, there is provided, according to an aspect of the present invention, a liquid crystal display device having a plurality of display modes of viewing angle properties different from each other, comprising:
a liquid crystal display panel including a first liquid crystal layer is to be controlled in a display state;
a backlight unit arranged opposite to the liquid crystal display panel;
a phase control liquid crystal element including a second liquid crystal layer arranged opposite to the liquid crystal display panel on a opposite side to the backlight unit, which controls a phase state of light emitted from the liquid crystal display panel;
a luminance visual angle control liquid crystal element having a third liquid crystal layer arranged between the liquid crystal display panel and the backlight unit, which controls a diffusion state of light irradiated from the backlight unit; and
a drive unit which drives the phase control liquid crystal element and the luminance visual angle control liquid crystal element in accordance with a respective one of the plurality of display modes.

According to another aspect of the present invention, there is provided a liquid crystal display device comprising:
a liquid crystal display panel including an array substrate, a counter substrate arranged opposite to the array substrate with a predetermined gap maintained therebetween, and a first liquid crystal layer held between the array substrate and the counter substrate;
a phase control liquid crystal element arranged opposite to the counter substrate of the liquid crystal display panel and including: a first substrate containing a first electrode and a first alignment film overlapping with the first electrode; a second substrate arranged opposite to the first substrate with a predetermined gap maintained therebetween and including a second electrode and a second alignment film overlapping with the second electrode and facing the first alignment film; and a second liquid crystal layer held between the first substrate and the second substrate and configured to control a scattering angle of light transmitting between the first substrate and second substrate;
a backlight unit configured to emit light beams of a high parallel degree toward the array substrate; and
a luminance visual angle control liquid crystal element arranged between the backlight unit and array substrate, and configured to control a luminance visual angle of light emitted from the backlight unit.

Additional advantages of the invention will be set forth in the description which follows, and in part will be obvious from the description, or may be leaned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross sectional view of a liquid crystal display device according to an embodiment of the present invention;

FIG. 2 is a plan view schematically showing a phase control liquid crystal element shown in FIG. 1;

FIG. 3 is a schematic diagram showing a cross section of a first liquid crystal layer shown in FIG. 1 in a state that no voltage is applied to the first liquid crystal layer;

FIG. 4 is a diagram showing an average refractive index ellipsoid of a liquid crystal molecule shown in FIG. 3;

FIG. 5 is a schematic diagram showing a cross section of a second liquid crystal layer shown in FIG. 1 in a state that the liquid crystal molecule of the second liquid crystal layer is oriented vertically;

FIG. 6 is a diagram showing an average refractive index ellipsoid of the liquid crystal molecule shown in FIG. 5;

FIG. 7 is a schematic diagram showing a cross section of the first liquid crystal layer shown in FIG. 1 in a state that a voltage is applied to the first liquid crystal layer;

FIG. 8 is a diagram showing an average refractive index ellipsoid of the liquid crystal molecule shown in FIG. 7;

FIG. 9 is an explanatory diagram showing a cross section of a third liquid crystal layer shown in FIG. 1 and an optical path of backlight in a state that no voltage is applied to the third liquid crystal layer; and

FIG. 10 is an explanatory diagram showing a cross section of the third liquid crystal layer shown in FIG. 1 and the optical path of backlight in a state that a voltage is applied to the third liquid crystal layer.

### DETAILED DESCRIPTION OF THE INVENTION

A liquid crystal display device, according to an embodiment of the present invention, will now be described in detail with reference to accompanying drawings.

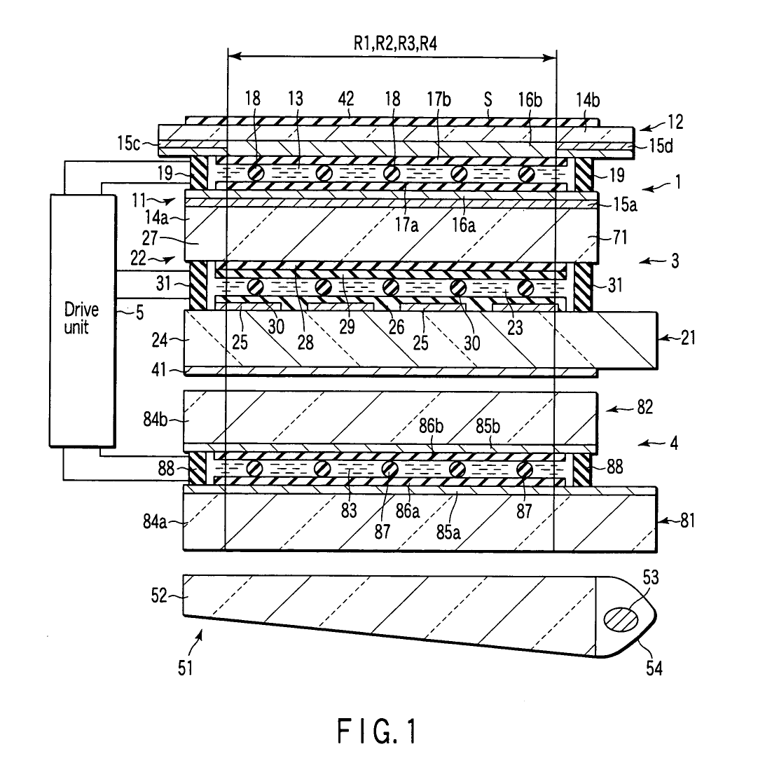

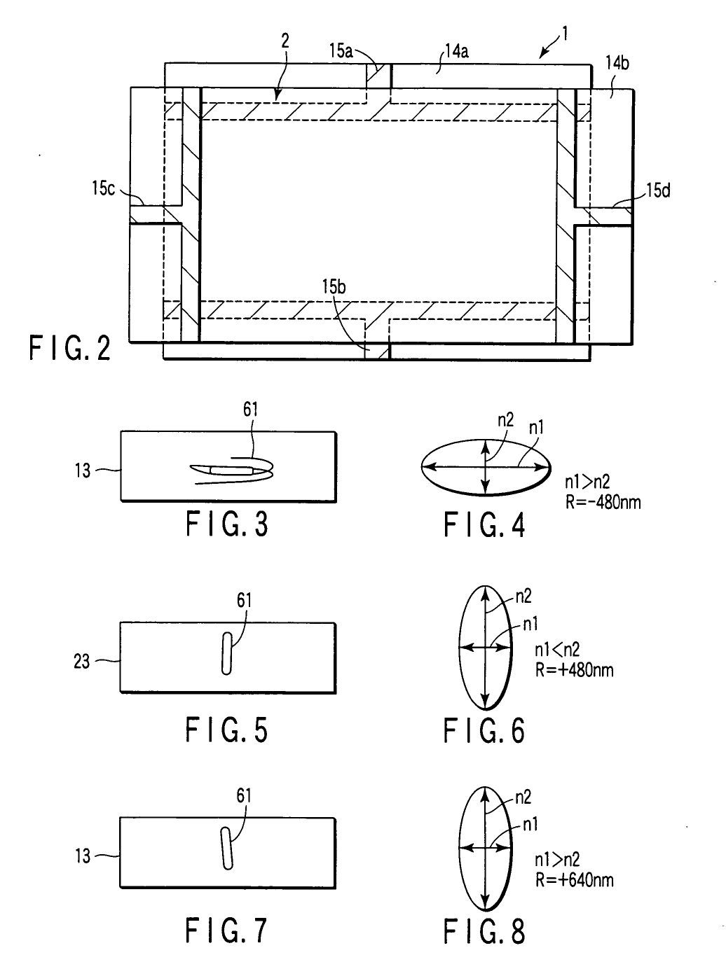

As shown in FIG. 1, the liquid crystal display device includes a phase control liquid crystal element 1, a liquid crystal display panel 3, a first polarizing plate 41, a second polarizing plate 42, a backlight unit 51, a luminance visual angle control liquid crystal element 4 and a drive unit 5. The phase control liquid crystal element 1 includes a first substrate 11, a second substrate 12 which is arranged opposite to the first substrate with a predetermined gap therebetween, and a first liquid crystal layer 13. The first substrate 11 includes a first sheet 14a made of, for example, polyester film or glass, as a transparent insulating substrate, a first electrode 16a arranged on the first sheet and made of a transparent conductive material such as ITO (indium tin oxide), and a first alignment film 17a arranged on the first electrode. The second substrate 12 includes a second sheet 14b made of, for example, polyester film or glass, as a transparent insulating substrate, a second electrode 16b arranged on the second sheet and made of a transparent conductive material such as ITO, and a second alignment film 17b arranged on the second electrode. The first alignment film 17a and the second alignment film 17b are rubbed so to have a pretilt angle of 5°.

The first substrate 11 and the second substrate 12 are arranged opposite to face each other such that the first alignment film 17a and the second alignment film 17b face each other, and to be kept away from each other by a predetermined gap by a plurality of first spacers 18. Each of the first spacers 18 is made of an insulating material. The first electrode 16a and the second electrode 16b are maintained to be insulated from each other. The first substrate 11 and the second substrate 12 has a scattering angle control region R1, which is a region where the first electrode 16a and second electrode 16b face each other, and the scattering angle of light passing through between the first substrate 11 and second substrate 12 can be controlled. The first substrate 11 and second substrate 12 are joined together with a sealing material 19 provided in peripheral portions of the first electrode 16a and second electrode 16b. The first liquid crystal layer 13 is interposed between the first substrate 11, the second substrate 12 and the sealing material 19.

The thickness of the first liquid crystal layer 13 is 5.0 μm. The liquid crystal material that forms the first liquid crystal layer 13 includes a predetermined chiral material added thereto in order to obtain the below specified properties. That is, a refractive index anisotropic difference (Δn) of the liquid crystal material is 0.072 with respect to a wavelength of 590 nm. The twisting angle of the liquid crystal molecule is 450° and the twisting pitch is 3.92 μm. The twisting of the liquid crystal molecule is in the counter-clockwise direction.

The first liquid crystal layer 13 described above has a function of controlling the scattering angle of light passing through between the first substrate 11 and the second substrate 12. In more detail, the first liquid crystal layer 13 controls the scattering angle of light by regulating the alignment of the liquid crystal molecule. In order to control the orientation of the liquid crystal molecule, a voltage is applied to the phase control liquid crystal element 1 to control the potential difference between the first electrode 16a and second electrode 16b. The first liquid crystal layer 13 can control a phase state of light emitted from the liquid crystal display panel 3.

Next, a method of manufacturing the phase control liquid crystal element 1 will now be described.

The first electrode 16a is formed on the prepared first sheet 14a, and the first alignment film 17a is applied on the first sheet and first electrode. After that, the first alignment film 17a is subjected to rubbing as an alignment film treatment process, and thus the first substrate 11 is formed. Meanwhile, in the second substrate 12, the second electrode 16b is formed on the prepared second sheet 14b, and the second alignment film 17b is applied on the second sheet and second electrode. After that, the second alignment film 17b is subjected to rubbing as an alignment film treatment process, and thus the second substrate 12 is formed.

Next, spacers are dispersedly provided on the first substrate 11 or second substrate 12, and then the sealing material 19 of, for example, a thermosetting type is applied on the periphery of the first substrate or second substrate. Subsequently, the first substrate 11 and second substrate 12 are arranged opposite to each other, and baked. In this manner, the first substrate 11 and second substrate 12 are joined together. After that, liquid crystal is filled between the first substrate 11 and second substrate 12. For the filling, for example, a vacuum injection method can be used. In this method, liquid crystal is injected from a liquid crystal injection port formed in a part of the sealing material 19 to fill a space between the substrates. The liquid crystal injection port is sealed by a sealant.

The phase control liquid crystal element 1 functions as a resistance detection-type touch panel. The phase control liquid crystal element 1 includes an entry region R3 where the first electrode 16a and second electrode 16b overlap with each other, and position data detection unit.

The first substrate 11 includes first resistance detection electrodes 15a and 15b connected to a rectangular first electrode (resistance layer) 16a and provided respectively on a pair of opposing sides of the first electrode. The second substrate 12 includes second resistance detection electrodes 15c and 15d arranged orthogonal to the first electrode (resistance layer) 16a, connected to a rectangular second electrode 16b and provided respectively on a pair of opposing sides of the second electrode.

The position data detection unit 2 contains the first resistance detection electrodes 15a and 15b and the second resistance detection electrodes 15c and 15d, and has the function of detecting the position data of an area pressed in the entry region R3. It should be noted that the second substrate 12 includes an entry surface S which overlaps with the entry region R3. Naturally, the second polarizing plate 42 is located on the entry surface S of the second substrate 12.

In this embodiment, the first resistance detection electrode3s 15a and 15b and the second resistance detection electrode3s 15c and 15d, which are designed to detect the position data of a pressed area are arranged at a total of four sites, two sites on top and two on bottom. As the outer surface of the second polarizing plate 42 (phase control liquid crystal element 1) is pressed, the first electrode 16a and the second electrode 16b are brought into contact with each other. With this structure, a pressed area can be detected by measuring the resistance between a pair of electrodes in combinations (that is, four combinations of between a pair of the first resistance detection electrode 15a and the second resistance detection electrode 15c, a pair of the first resistance detection electrode 15a and the second resistance detection electrode 15d, a pair the first resistance detection electrode 15b and the second resistance detection electrode 15c, and a pair the first resistance detection electrode 15b and the second resistance detection electrode 15d) when they are in contact with each other. It should be noted that the first resistance detection electrodes 15a and 15b and the second resistance detection electrode 15c and 15d are formed by depositing or sputtering a low-resistance metal such as Al or Mo, followed by patterning. In this manner, the phase control liquid crystal element 1 is completed.

A liquid crystal display panel 3 is of a TN (twisted nematic) mode. The liquid crystal display panel 3 comprises an array substrate 21 serving as a third substrate, a counter substrate 22 serving as a fourth substrate and the second liquid crystal layer 23. The array substrate 21 includes a glass substrate 24 serving as a transparent insulating substrate, a plurality of pixel electrodes 25 formed on the glass substrate, and an alignment film formed on the glass substrate to contain each pixel electrode 25. The array substrate 21 includes various types of wirings and thin film transistors (to be called TFTs hereinafter) serving as switching elements, although not shown in the figure, formed on the glass substrate 24. The counter substrate 22 includes a glass substrate 27 serving as a transparent insulating substrate, a common electrode 28 formed on this glass substrate, and an alignment film 29 formed on the common electrode and the glass substrate. In this embodiment, the first sheet 14a and the glass substrate 27 are formed in one. Therefore, the first substrate 11 of the phase control liquid crystal element 1 and the counter substrate 22 of the liquid crystal display panel 3 have a transparent common substrate 71, and they are made of the same substrate. The pixel electrodes 25 and common electrode 28 are formed of a transparent conductive material such as ITO. The alignment film 26 and the alignment film 29 are rubbed so to have a pretilt angle of 5°.

The array substrate 21 and the counter-substrate 22 are arranged opposite to each other to be kept away from each other by a predetermined gap by a plurality of second spacers 30. The array substrate 21 and the counter substrate 22 are arranged such that the pixel electrodes 25 and common electrode 28 face each other, and they have a display region R2 which displays images. In this embodiment, the display region R2 overlaps with the above-described scattering angle control region R1. The array substrate 21 and the counter substrate 22 are joined together with a sealing material 31 provided in peripheral portions of both of the substrates, on an outer side of the display region R2. The second liquid crystal layer 23 is held between the array substrate 21, the counters substrate 22 and the sealing material 31.

The thickness of the second liquid crystal layer 23 is 5.0 μm. The liquid crystal material that forms the second liquid crystal layer 23 includes a predetermined chiral material added thereto in order to obtain the below specified properties. That is, the refractive index anisotropic difference (Δn) of the liquid crystal material is 0.092 with respect to a wavelength of 590 nm. The twisting angle of the liquid crystal molecule is 90° and the twisting pitch is 60 μm. The twisting of the liquid crystal molecule is in the counter-clockwise direction.

In the display region R2, a color filter having coloring layers of red (R), green (G) and blue (B), though it is not shown in the figure, is arranged on one of the array substrate 21 and counter-substrate 22. With this structure, the liquid crystal display panel 3 is able to display images in color.

A first polarizing plate 41 is arranged on an outer surface (outer surface side) of the array substrate 21, and a second polarizing plate 42 is arranged on an outer surface (outer surface side) of the second substrate 12. The first polarizing plate 41 and the second polarizing plate 41 are arranged in a Cross Nicol manner. With this arrangement, the liquid crystal display panel 3 is of a normally white display mode in which display is turned to black when a voltage is applied. A backlight unit 51 is provided on an outer surface side of the array substrate 21. The backlight unit 51 includes a light guiding member 52 facing the first polarizing plate 41 and containing a light guiding plate, a light source 53 arranged to face one side end of the light guiding member, and a reflecting plate 54.

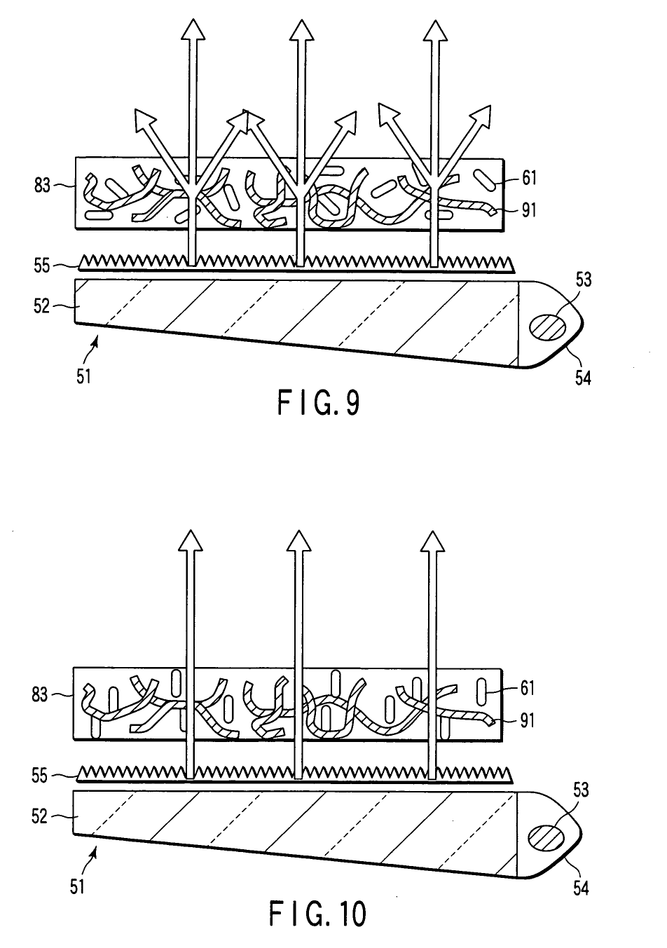

The backlight unit 51 includes a high light collecting prism sheet 55 (FIGS. 9 and 10) arranged opposite to the surface of the light guiding member 52. The prism sheet 55 has the function of enhancing the parallel degree of beams of the light emitted from the backlight unit 51. The prism sheet 55 has the structure of enhancing the parallel degree of the beams more than that of a prism sheet that is normally used in the liquid crystal display device for a notebook PC (personal computer). As the prism sheet 55, those which can extremely enhance the parallel degree of the beams emitted from the backlight unit, that is, for example, Collimate Sheet, a product of Nagase & Co. Inc., is used.

The luminance visual angle control liquid crystal element 4 is arranged between the backlight unit 51 and the first polarizing plate 41. The luminance visual angle control liquid crystal element 4 includes a fifth substrate 81, a sixth substrate 82 and a third liquid crystal layer 83. The fifth substrate 81 further includes a glass substrate 84a serving as a transparent insulating substrate, a third electrode 85a formed on the glass substrate and an alignment film 86a formed to cover the third electrode on the glass substrate. The sixth substrate 82 further includes a glass substrate 84b serving as a transparent insulating substrate, a fourth electrode 85b formed on the glass substrate and an alignment film 86b formed to cover the fourth electrode on the glass substrate. The third electrode 85a and fourth electrode 85b are formed of a transparent conductive material such as ITO. The alignment film 86a and the alignment film 86b are subjected to rubbing.

The fifth substrate 81 and sixth substrate 82 are arranged opposite to each other to be kept away from each other by a predetermined gap by a plurality of third spacers 87. The fifth substrate 81 and sixth substrate 82 are arranged such that the third electrode 85a and fourth electrode 85b face each other, and they have a light diffusion control region R4 which can control the diffusion of the light emitted from the backlight unit and irradiated on the luminance visual angle control liquid crystal element 4. In this embodiment, the light diffusion control region R4 overlaps with the above-described display region R2.

The fifth substrate 81 and the sixth substrate 82 are joined together with a sealing material 88 provided in peripheral portions of both of the substrates, on an outer side of the light diffusion control region R4. The third liquid crystal layer 83 is held between the fifth substrate 81, the sixth substrate 82 and the sealing material 88.

Here, the third liquid crystal layer 83 according to this embodiment will be described. The thickness of the third liquid crystal layer 83 is 25.0 μm. The third liquid crystal layer 83 is made of a liquid crystal material that is prepared by dissolving a light cross-linking polymer at 2 wt % into a nematic liquid crystal having a refractive index anisotropic difference (Δn) of 0.23. The liquid crystal material of the third liquid crystal layer 83 is a transparent liquid at room temperature.

In order to fill the space surrounded by the fifth substrate 81, sixth substrate 82 and sealing material 88, with the third liquid crystal layer 83, the conventional liquid crystal injecting method as well as the vacuum injection method or the like can be employed. Therefore, while injecting, the liquid crystal is in the state of liquid. UV light is applied to the liquid crystal injected to create polymers (polymer network) and at the same time, liquid crystal molecules are precipitated. It can be regarded that an orientation of the liquid crystal molecules of the third liquid crystal layer 83 is substantially at random. The refractive index of the created polymers is equal to the ordinary index of the liquid crystal molecules precipitated.

The fifth substrate 81 of the luminance visual angle control liquid crystal element 4 is arranged opposite to the backlight unit 51. The sixth substrate 82 is arranged opposite to the first polarizing plate 41. It should be noted that the sixth substrate 82 may be adhered to the second polarizing plate 42, for example, via glue which is not shown in the figure.

The drive unit 5 drives the phase control liquid crystal element 1 and the luminance visual angle control liquid crystal element 4 in accordance with a respective one of the plurality of display modes. The drive unit 5 drives the liquid crystal display panel 3.

Here, the present inventors tested various display properties including the luminance viewing angle, contrast viewing angle, frontal luminance and frontal contrast property in two cases where an image is displayed on a liquid crystal display device, one case where a voltage being applied to the phase control liquid crystal element 1 and to the luminance visual angle control liquid crystal element 4, and the other where no voltage being applied thereto. In this test, the liquid crystal display panel 3 was driven at a drive voltage of 4V via the TFTs and the phase control liquid crystal element 1 was driven at a drive voltage of 10V. Further, the luminance visual angle control liquid crystal element 4 was driven at a drive voltage of 5V. The backlight unit 51 was on, and the liquid crystal display device was placed under an environment of an illumination of 0lx (lux).

First, various display properties obtained in the case where no voltage was applied to the phase control liquid crystal element 1 (arranged between the first electrode 16a and the second electrode 16b) and to the luminance visual angle control liquid crystal element 4 (arranged between the third electrode 85a and the fourth electrode 85b) will be described.

The viewing angle having a luminance of 30 cd/m² or more is wide as ±60° in a horizontal direction, and the viewing angle having a contrast ratio 10:1 or more is sufficiently wide as ±80° in a horizontal direction. The frontal luminance is sufficiently high as 300 cd/m². From these data, it can be understood that a frontal luminance and luminance viewing angle of equal levels to those of the case where an image is displayed using a liquid crystal display device structured without the phase control liquid crystal element 1 or the luminance visual angle control liquid crystal element 4 built therein, can be obtained. Further, the frontal contrast is 500:1, which is a high value of an equal level to that of the case of the structure without the phase control liquid crystal element 1 or the luminance visual angle control liquid crystal element 4.

Next, various display properties obtained in the case where a voltage of 10V was applied to the phase control liquid crystal element 1 (arranged between the first electrode 16a and the second electrode 16b) and a voltage was applied to the luminance visual angle control liquid crystal element 4 (arranged between the third electrode 85a and the fourth electrode 85b) will be described.

The viewing angle having a luminance of 30 cd/m² or more is sufficiently narrow as ±20° in a horizontal direction, and the viewing angle having a contrast ratio 10:1 or more is sufficiently narrow as ±15° in a horizontal direction. Further, the viewing angle having a contrast ratio 1:1 or more is sufficiently narrow as ±20° in a horizontal direction, and the display was not at all legible when the horizontal viewing angle was 20° or more.

Meanwhile, the frontal luminance is 600 cd/m², which is a double of that of the case where an image is displayed on a conventional liquid crystal display device manufactured without providing the luminance visual angle control liquid crystal element 4. Further, the frontal contrast is 1000:1, which is a higher value as compared to that of the case of the structure without the phase control liquid crystal element 1, or the state where no voltage was applied to the phase control liquid crystal element.

Next, the mechanism of controlling the viewing angle of the liquid crystal display device (the scattering angle of the light from the backlight unit transmitted the liquid crystal display panel 3) will now be described with reference to FIGS. 3 to 8.

Of the viewing angle properties, the contrast visual angle property and luminance visual angle property are particularly important. Of these, the contrast visual angle property is greatly influenced by the visual angle at the black display mode. In a display mode which utilizes the state where the liquid crystal molecule 61 is arranged substantially vertically, such as in the TN mode, an excellent black display property can be obtained. Therefore, in many cases, the black display is carried out while the liquid crystal molecules are arranged substantially vertically. However, while the liquid crystal molecule 61 is arranged substantially vertically, a phase difference is created in an oblique view. More specifically, approximately, the phase difference resulting by multiplying refractive index anisotropic difference (Δn) of the liquid crystal material, the thickness of the liquid crystal layer and the visual angle is created.

As illustrated in FIGS. 3 to 8, in this embodiment, a phase difference of +480 nm (X visual angle) is created. However, the phase difference (FIG. 4) in the case where no voltage is applied to the first liquid crystal layer 13 is −480 nm (X visual angle), and therefore the total phase difference with that of the second liquid crystal layer 23 is 0. From the descriptions provided above, it can be understood that with the phase control liquid crystal element 1 comprising the first liquid crystal layer 13, the contrast visual angle property can be widened as compared to the case where the structure without the phase control liquid crystal element.

On the other hand, in the state where a voltage is applied to the first liquid crystal layer 13, the twisting of the liquid crystal molecule is released and the liquid crystal molecule is oriented substantially vertically (FIG. 8), a positive uniaxial (+640 nm) is obtained as in the case of the second liquid crystal layer 23. Therefore, the total phase difference including that of the second liquid crystal layer 23 is 1120 nm. From the descriptions provided above, it can be understood that with the phase control liquid crystal element 1 comprising the first liquid crystal layer 13, the contrast visual angle property can be narrowed significantly as compared to the case where the structure without the phase control liquid crystal element.

Next, the mechanism of controlling the viewing angle of the liquid crystal display device by the luminance visual angle control liquid crystal element 4, will now be described with reference to FIGS. 9 and 10.

While the voltage is not applied to the third liquid crystal layer 83 of the luminance visual angle control liquid crystal element 4, the orientation of liquid crystal molecules 61 is substantially at random. Therefore, the refractive index is an average of the ordinary index and extraordinary index. On the other hand, the refractive index of polymers 91 is equal to the ordinary index of the liquid crystal molecules 61 precipitated. Therefore, the refractive index anisotropic difference (Δn) is a half of the refractive index anisotropic difference (Δn) described above, that is, about 0.115, and thus a difference in refractive index is created.

Meanwhile, the polymers 91 have a random three-dimensional structure, and therefore the light emitted from the backlight unit transmitted the prism sheet 55 is diffused by the luminance visual angle control liquid crystal element 4. Therefore, a wide luminance viewing angle can be obtained as in the case of using a conventional liquid crystal display device manufactured without providing the luminance visual angle control liquid crystal element 4.

While a sufficient voltage is applied to the third liquid crystal layer 83 so that the liquid crystal molecules 61 of the third liquid crystal layer 83 are orientated substantially vertically (FIG. 10), the orientation of liquid crystal molecules 61 is substantially vertical. Therefore, the refractive index to the traveling direction of the light incident on the third liquid crystal layer 83 is the ordinary index. On the other hand, the refractive index of polymers 91 is equal to the ordinary index of the liquid crystal molecules 61 precipitated. Therefore, a difference in refractive index between the polymers 91 and liquid crystal molecules 61 is not created, and the light from the backlight unit that transmitted the prism sheet 55 is directly transmitted through the luminance visual angle control liquid crystal element 4.

As described above, light beams having a sufficiently high parallel degree, which is achieved by the prism sheet 55, can be emitted to the liquid crystal display panel 3 (FIG. 1). With this structure, a much narrower luminance viewing angle can be obtained as compared to that of the case of the conventional liquid crystal display device, which does not include the luminance visual angle control liquid crystal element 4. Here, in accordance with the narrowed luminance viewing angle, the frontal luminance is much higher that that of the case where the conventional liquid crystal display device is used.

In the liquid crystal display device comprising the phase control liquid crystal element 1 and the luminance visual angle control liquid crystal element 4 having the above-described structure, the phase control liquid crystal element includes the first liquid crystal layer 13. The first liquid crystal layer 13 can control the phase difference and traveling direction of the light of the backlight transmitting the liquid crystal display panel 3. As described above, the phase control liquid crystal element 1 can control the viewing angle and contrast visual angle.

With the above-described structure, even if a mobile PC, mobile telephone, PDA, electronic notepad, tablet PC, etc. are used in a public place, the viewing angle can be narrowed when the user does not wish other persons to monitor the contents of the display or the viewing angle can be widened when the displayed image need be monitored more than one person. In this manner, the trouble that displayed contents are undesirably monitored can be avoided. Further, if desired, more than one person can monitor the displayed image at the same time easily. During this operation, the viewing angle can be easily controlled by adjusting the voltage applied between the first electrode 16a and the second electrode 16b. The controlling of these display properties can be done without having to substantially increase the power. Thus, the display properties of the liquid crystal display device can be controlled easily with a switch or a volume control.

In a liquid crystal display device in which nematic liquid crystals are controlled to be orientated from substantially a vertical arrangement to a horizontal arrangement, oblique arrangement or an arrangement of either one of these with some twisting, such as the MVA mode, twisted nematic mode (TN mode), homogeneous mode (HOMO mode) or hybrid align nematic mode, the first polarizing plate 41 and second polarizing plate 42 are arranged such that while the nematic liquid crystal is oriented substantially vertically (voltage applied state), the display is black. During this state, the second liquid crystal layer 23 is regarded in terms of optics as of a substantially positive uniaxial crystal type. Therefore, in the field of view in an oblique direction to the display screen, a phase difference is created. Therefore, as compared to the case where the display screen is monitored from a front side, the contrast ratio is lowered.

In the first liquid crystal layer 13, the refractive index anisotropic difference (Δn) of the liquid crystal material is small, the twisting pitch of the liquid crystal molecule is short and the twisting angle of the molecule is 450°. The first liquid crystal layer 13 has a sufficiently low optical activity as compared to that of the second liquid crystal layer 23. Therefore, in the state in which no voltage is applied between the first electrode 16a and the second electrode 16b, the first liquid crystal layer 13 serves as a retardation film that can be regarded as of a negative uniaxial crystal.

Consequently, in the above-described state, the phase difference of the second liquid crystal layer 23 in the state where the molecule is oriented substantially vertically is canceled out by that of the first liquid crystal layer 13, thereby suppressing the lowering of the contrast in the field of view in an oblique direction. In particular, when the absolute value of the phase difference of the second liquid crystal layer 23 is the same as the absolute value of the phase difference of the first liquid crystal layer 13, the maximum effect can be obtained. In addition, when the twisting directions of the first liquid crystal layer 13 and the second liquid crystal layer 23 are made to coincide with each other, the first liquid crystal layer 13 functions to widen the horizontal direction viewing angle of the liquid crystal display panel 3 (TN mode).

The above-described effect is prominent in the case where the twisting angle of the liquid crystal molecule of the first liquid crystal layer 13 is controlled as described in the followings. That is, while a voltage is applied to the phase control liquid crystal element 1, the liquid crystal molecule is oriented substantially vertically to the plane of the first substrate 11 and the plane of the second substrate 12, and while no voltage is applied thereto, the liquid crystal molecule is oriented in a twisting angle of 360° or more. Alternatively, while no voltage is applied to the phase control liquid crystal element 1, the liquid crystal molecule is oriented substantially vertically to the plane of the first substrate 11 and the plane of the second substrate 12, and while a voltage is applied thereto, the liquid crystal molecule is oriented in a twisting angle of 360° or more.

The phase control liquid crystal element 1 is arranged to be located between the liquid crystal display panel 3 and the second polarizing plate 42. With this arrangement, the second polarizing plate 42 serves as a polarizer. Here, the second polarizing plate 42 should desirably be attached on the second sheet 14b located on the display screen side via glue which is not shown in the figure. If it is not attached with glue, an air interface is created between the phase control liquid crystal element 1 and the second polarizing plate 42. Further, if the gap is narrow, Newton ring becomes visually recognizable, which is a problem. On the other hand, if the gap between the phase control liquid crystal element 1 and the second polarizing plate 42 is wide, a spacer or the like for maintaining the gap is required, and the thickness of the entire liquid crystal display device is increased.

Similarly, the phase control liquid crystal element 1 and the liquid crystal display panel 3 should desirably be attached together without a gap provided there between. In the case where the first sheet 14a and second sheet 14b of the phase control liquid crystal element 1 are made of a flexible plastic or a thin plate glass, if suffices if the phase control liquid crystal element is adhered to the liquid crystal display panel 3 via glue which is not shown in the figure.

By providing both of the phase control liquid crystal element 1 and the luminance visual angle control liquid crystal element 4, it becomes possible to control the contrast visual angle and luminance visual angle at the same time. More specifically these properties can be controlled by controlling the voltages applied to these liquid crystal layers, respectively. In this manner, the visual angles can be adjusted freely in an analog manner from the widest visual angle to the narrowest angle. In a state where the visual angle is narrowed by the luminance visual angle control liquid crystal element 4 (that is, a state where the third liquid crystal layer 83 is transparent), the emitted light can be concentrated in the front direction of the display screen. In this case, a sufficient luminance can be obtained even if the intensity of the backlight is weakened, thereby making it possible to reduce the consumption power.

In the state where no voltage is applied to the third liquid crystal layer 83, the orientation of the liquid crystal molecules is at random, and it is not necessary to control the orientation with the alignment films 86a and 86b. However, it is desirable that the alignment films 86a and 86b should be provided to protect the third electrode 85a and the fourth electrode 85b, and to increase the retention property of the third liquid crystal layer 83. However, in this case, the alignment film treatment process, that is, for example, rubbing, is not necessary.

The first electrode 16a and the second electrode 16b of the phase control liquid crystal element 1 are formed as on integral unit. The third electrode 85a and the fourth electrode 85b of the luminance visual angle control liquid crystal element 4 are formed as an integral unit. With this structure, the phase control liquid crystal element 1 and the luminance visual angle control liquid crystal element 4 each has a sufficiently low consumption power as compared to that of the liquid crystal display panel 3, and further they can be easily manufactured. Further, in place of the glass substrates 84a and 84b, the luminance visual angle control liquid crystal element 4 can be easily manufactured using a plastic substrate or thin plate glass. In this case, the total thickness and total weight of the luminance visual angle control liquid crystal element 4 can be further reduced.

The phase control liquid crystal element 1 has such a structure that a first alignment film 17a and a second alignment film 17b are formed in a conventional resistance detection-type touch panel, with the first liquid crystal layer 13 held therebetween. Therefore, except for the steps of forming the first alignment film 17a and the second alignment film 17b, and injecting liquid crystal, the phase control liquid crystal element 1 can be manufactured by use of the conventional method of manufacturing a resistance detection-type touch panel and conventional members. Therefore, it can be formed without increasing the weight and thickness of the liquid crystal display device as a whole. Further, the liquid crystal display device can be manufactured without substantially increasing the production cost from the conventional method.

The phase control liquid crystal element 1 has the position data detecting unit 2. With the position data detecting unit 2, the position data of a pressed area of the entry region R3 can be accurately detected. The phase control liquid crystal element 1 has includes the first liquid crystal layer held therein, but it can detect the position data of a pressed area as accurately as in the conventional resistance detection-type touch panel.

The first substrate 11 and the counter substrate 22 have a common substrate 71, and they are made of the same substrate. With this structure, it is possible to reduce the weight and thickness of the liquid crystal display device as a whole.

Lastly, the present invention is not limited to the above-described embodiments and examples, but can be remodeled into various versions within the scope of the invention. For example, it suffices if the luminance visual angle control liquid crystal element 4 is made of, PDLC (polymer dispersed liquid crystal), PNLC (polymer network liquid crystal) or PSCT (polymer stabilized cholesteric texture).

1. A liquid crystal display device having a plurality of display modes of viewing angle properties different from each other, comprising:
a liquid crystal display panel including a first liquid crystal layer which is to be controlled in a display state;
a backlight unit arranged opposite to the liquid crystal display panel;
a phase control liquid crystal element including a second liquid crystal layer arranged opposite to the liquid crystal display panel on a opposite side to the backlight unit, which controls a phase state of light emitted from the liquid crystal display panel;
a luminance visual angle control liquid crystal element having a third liquid crystal layer arranged between the liquid crystal display panel and the backlight unit, which controls a diffusion state of light irradiated from the backlight unit; and
a drive unit which drives the phase control liquid crystal element and the luminance visual angle control liquid crystal element in accordance with a respective one of the plurality of display modes.

2. A liquid crystal display device comprising:
a liquid crystal display panel including an array substrate, a counter substrate arranged opposite to the array substrate with a predetermined gap maintained therebetween, and a first liquid crystal layer held between the array substrate and the counter substrate;
a phase control liquid crystal element arranged opposite to the counter substrate of the liquid crystal display panel and including: a first substrate containing a first electrode and a first alignment film overlapping with the first electrode; a second substrate arranged opposite to the first substrate with a predetermined gap maintained therebetween and including a second electrode and a second alignment film overlapping with the second electrode and facing the first alignment film; and a second liquid crystal layer held between the first substrate and the second substrate and configured to control a scattering angle of light transmitting between the first substrate and second substrate;
a backlight unit configured to emit light beams of a high parallel degree toward the array substrate; and
a luminance visual angle control liquid crystal element arranged between the backlight unit and array substrate, and configured to control a luminance visual angle of light emitted from the backlight unit.

3. The liquid crystal display device according to claim 2, wherein the second liquid crystal layer is controlled such that when a voltage is applied between the first electrode and the second electrode, the second liquid crystal layer orients liquid crystal molecules substantially vertically to a plane of the first substrate and a plane of the second substrate, and when the voltage is not applied thereto, the second liquid crystal layer orients the liquid crystal molecules at a twisting angle of 360° or more, or
when a voltage is not applied between the first electrode and the second electrode, the second liquid crystal layer orients liquid crystal molecules substantially vertically to a plane of the first substrate and a plane of the second substrate, and when the voltage is applied thereto, the other liquid crystal layer orients the liquid crystal molecules at a twisting angle of 360° or more.

4. The liquid crystal display device according to claim 2, wherein the first and second electrodes are each formed to have a rectangular shape and the phase control liquid crystal element further comprises
an entry region where the first electrode and the second electrode overlap with each other, and
a position data detection unit including first resistance detection electrodes connected to the first electrode and respectively provided on a pair of opposing sides of the first electrode, and second resistance detection electrodes arranged orthogonal to the first electrode, connected to the second electrode and respectively provided on a pair of opposing sides of the second electrode, and configured to detect position data of a pressed area of the entry region.

5. The liquid crystal display device according to claim 2, further comprising a polarizing plate arranged on an outer surface side of the second substrate.

6. The liquid crystal display device according to claim 5, further comprising an other polarizing plate arranged on an outer surface side of the array substrate.

7. The liquid crystal display device according to claim 2, wherein the first substrate and the counter substrate are made of a same substrate.

8. The liquid crystal display device according to claim 2, wherein the light diffusion control liquid crystal element comprises
a third substrate,
a fourth substrate arranged opposite to the third substrate with a predetermined gap maintained therebetween, and
a third liquid crystal layer held between the third substrate and the fourth substrate.
